(19) United States
(12) Patent Application Publication
(10) Pub. No.: US 2010/0299531 A1
(43) Pub. Date: Nov. 25, 2010

(54) Methods for Processing Genomic Information and Uses Thereof

(75) Inventors: Mitch Webster, Auckland (NZ); Oliver Horlacher, Wellington (NZ)

Correspondence Address: SPECKMAN LAW GROUP PLLC, 1201 THIRD AVENUE, SUITE 330, SEATTLE, WA, 98101, US

(73) Assignee: FIDELITYGENETIC LTD., Auckland (NZ)

(21) Appl. No.: 10/599,049

(22) PCT Filed: Mar. 17, 2005
(86) PCT No.: PCT/NZ05/00048

§ 371 Date: Jul. 16, 2007

(30) Foreign Application Priority Data
Mar. 17, 2004 (NZ) 531824

(51) Int. Cl. G06F 17/30; G06F 12/14

(52) U.S. Cl. 713/189; 707/802; 707/736; 707/E17.005

(57) ABSTRACT

Methods for processing and storing genomic information in a secure manner are described. In particular, methods for processing, splitting and storing genomic information or portions thereof are disclosed. An individual's genomic information is digitized and a splitting algorithm applied to fragment and randomise the digitized genomic information into at least two separate datasets. Access to at least one dataset is retained by the individual and the second dataset is stored on a central server as a secure database record. Each dataset in isolation presents uninformative data and it is only when all datasets are combined that the data is capable of being presented into a useable and informative format.

### TECHNICAL FIELD

The present invention relates to methods of processing and storing personal information in a secure manner, and in particular but not solely to methods for securely processing and securely storing genomic information from one or more individuals.

### BACKGROUND

The genome of an organism is believed to contain all the information required for the growth, development and maintenance of that organism. The sequencing of the human genome has signaled a new era in medicine, one in which genetic contributions to human health can be more readily considered. The publication of the draft human genome sequence (Eric S. Lander, et al. “Initial Sequencing and Analysis of the Human Genome.” Nature 409, 860-921 (Feb. 15, 2001) included an estimate that the human genome comprised only about 30,000 to 40,000 protein-encoding genes—much lower than previous estimates of around 100,000. A large number of these genes are involved in an individual's predisposition to disease. Furthermore, it is believed all diseases have a genetic component, whether the disease is inherited or results from the body's response to an environmental stress, such as, for example, exposure to viruses or toxins. An analysis of an individual's or population's genomic information will allow a determination of the genetic component or components that contribute to or cause disease.

As polynucleotide sequencing methods become amenable to the rapid determination of the genomic information of an individual or population, this genomic information will become available to individuals or populations, for example, as part of their medical profile. Decisions relating to the health of an individual or population can thereby be informed by an analysis of their genomic information.

For example, the genomic information of an individual or a population has application in diagnostic, therapeutic and preventative methods, such as, for example, gene testing, pharmacogenomics, gene therapy, genetic counseling, and genetic disease information.

The prospect of a genomic medicine in which decisions relating to the health of an individual or population are informed by their genomic information, such as, for example, the determination of an individual's predisposition to disease, has the potential for significant benefit and significant detriment. For example, application of an individual's genomic information within the emerging field of pharmacogenomics may allow the identification of a subset of those drugs used to treat a particular disease or condition that are more likely to have therapeutic or preventative benefit to that individual. In another example, the determination of an individuals predisposition to disease based on their genomic information has the potential for discrimination in, for example, health insurance coverage or employment. The genomic information of an individual could be used to exclude high risk individuals from health insurance coverage by either denying or limiting coverage or by charging prohibitive rates. Conversely, low risk individuals may benefit from reduced health insurance costs.

The potential for great benefit and great detriment demands that access to an individual's genomic information be controlled. This is particularly important in situations where part or all of an individual's genomic information is stored, for example, electronically in a database. For example, the non-secure storage of an individual's genomic information at a central database may allow the disclosure of the genomic information without the consent of the individual. It is towards methods that address issues relating to the privacy of genomic information and/or which ensure the safe and appropriate use of genomic information that the present invention is directed.

It is further towards methods and processes of processing all or part of an individual's or population's genomic information that enable the secure storage of said genomic information that the present invention is directed.

It is therefore an object of the present invention to provide methods for the processing of genomic information to enable the secure storage of genomic information, or at least to provide, the public with useful choice.

### SUMMARY OF THE INVENTION

In one aspect, the invention provides a method for securely storing genomic information, said method comprising obtaining genomic information of one or more individuals, separating the genomic information into more than one dataset, storing at least one such dataset in a portable storage device, storing the remainder of the datasets in at least one central database, wherein the portable storage device is the property of the one or more individuals whose genomic information is partly contained therein, and wherein the genomic information is rendered informative only when the dataset or datasets stored in the portable storage device is combined with the dataset or datasets stored in the central database or databases.

In one embodiment, the information of one dataset may at least in part overlap with that of another dataset. In another embodiment, the information in at least one dataset may be encrypted. In one example, the information present in one dataset that is also present in one or more other datasets is encrypted. In a further example where the information of at least one dataset is encrypted, one or more other datasets provides one or more keys for decryption. In yet a further example where the information of at least one dataset is encrypted, more than one encryption method is used to encrypt different parts of the information comprising the dataset(s).

In one embodiment, said genomic information comprises nucleotide sequence information and/or annotation information.

In another aspect the invention provides a method for processing genomic information for secure storage wherein said genomic information comprises a representation of the nucleotide sequence of at least part of the genome of at least one individual, said method comprising converting a nucleotide sequence into one or more fragments, representing the nucleotide sequence of one or more of said fragments by means of a unique identifier, denoting the unique identifier representing a fragment by means of a positional notation according to the position of the represented fragment in the nucleotide sequence, separating at least some of the positional notations(s) and at least some of the unique identifier(s) into at least two data sets, storing at least some of at least one dataset in a portable electronic storage device, and storing at least the remainder of the dataset(s) on at least one central database, wherein the portable storage device is the property of the one or more individuals whose genomic information is partly contained therein, and wherein the genomic information is rendered informative only when the dataset or datasets stored in the portable storage device is combined with the dataset or datasets stored in the central database or databases.

In another aspect the invention provides a method for processing genomic information for secure storage wherein said genomic information comprises a representation of the nucleotide sequence of at least part of the genome of at least one individual, said method comprising converting a nucleotide sequence into one or more fragments, representing the nucleotide sequence of one or more of said fragments by means of a unique identifier, denoting the unique identifier representing a fragment by means of a positional notation according to the position of the represented fragment in the nucleotide sequence, separating at least some of the positional notation(s) and at least some of the unique identifier(s) into at least two data sets, storing at least some of at least one dataset separately from the remainder of the dataset(s), wherein access to at least some of at least one dataset may be authorised only by and/or is controlled by the one or more individuals whose genomic information is partly contained therein and/or wherein at least some of at least one dataset is the property of the one or more individuals whose genomic information is partly contained therein, and wherein the genomic information is rendered informative only when the datasets are combined.

Preferably the representation of the sequence of nucleotides of the one or more fragments by a unique identifier is facilitated by means of, for example, a method which correlates a string of n characters of a representation of a nucleotide sequence with a unique identifier which identifies that string.

In one embodiment, such a method utilises a lookup table.

In one embodiment, the nucleotide sequence is converted into fragments of the same length. In an alternative embodiment, the nucleotide sequence is converted into fragments of varying lengths.

Optionally the method comprises or includes randomising the sequence of unique identifiers and their associated positional notations, separating at least some of the positional notations from at least some of the unique identifiers whilst maintaining the association of each unique identifier with its associated positional notation. For example, the association of a given unique identifier with its positional notation is maintained by their relative position within each dataset. Alternatively, the association of a given unique identifier with its positional notation is provided by a unique association identifier.

In one example, said unique identifier(s) and/or positional notation(s) and/or association identifier(s) is or are alphanumeric.

In another aspect, the invention provides a method for reducing the informativeness of genomic information for the secure storage of said genomic information, wherein said genomic information comprises representation information comprising a representation of the nucleotide sequence of at least part of the genome of at least one individual and/or annotation information relating to said genome, and wherein said method comprises obtaining genomic information of one or more individuals, randomising the representation of the nucleotide sequence and/or the annotation information according to a process that generates information to unrandomise said representation information and/or annotation information, and separating said representation information and/or annotation information from the information to unrandomise said representation and/or annotation information, wherein access to at least some of said information to unrandomise said representation information and/or annotation information may be authorised only by and/or is controlled by the one or more individuals whose genomic information may thereby be unrandomised and/or wherein at least some of said information to unrandomise said representation and/or annotation information is the property of the one or more individuals whose genomic information may thereby be unrandomised, and wherein the genomic information is rendered informative only when the representation information and/or annotation information and the information to unrandomise said representation information and/or annotation information are combined.

In a further aspect, the invention provides a method to reduce the informativeness of genomic information wherein said method comprises or includes a method of processing genomic information as herein described with or without reference to the examples herein.

In a further aspect, the present invention provides a method for processing genomic information substantially as herein described with or without reference to the examples here.

In yet a further aspect, the invention provides a method for increasing the informativeness of stored genomic information, wherein said stored genomic information comprises or includes two or more separately stored datasets, at least one of which is stored in a portable storage device and the remainder of which are stored in at least one central database, and wherein the genomic information of any dataset(s) is uninformative in the absence of the remainder of datasets, said method comprising or including accessing said datasets, and combining the information of said datasets thereby to yield informative genomic information.

In yet a further aspect, the invention provides a method for increasing the informativeness of processed genomic information wherein said processed genomic information is provided in more than one dataset, and wherein at least part of at least one such dataset comprises a randomised representation of the nucleotide sequence of at least part of the genome of at least one individual and/or randomised annotation information relating to said genome, and wherein at least one other dataset comprises at least part of the information required to unrandomise at least part of said representation and/or annotation information, said method comprising or including accessing said dataset(s) comprising at least part of the information required to unrandomise at least part of said representation and/or annotation information, and unrandomising said representation and/or annotation information to yield informative genomic information.

In yet a further aspect, the invention provides a method for increasing the informativeness of stored genomic information, wherein said stored genomic information comprises or includes randomised representation information comprising a randomised representation of the nucleotide sequence of at least part of the genome of at least one individual and/or randomised annotation information relating to said genome(s) and information to unrandomise said representation information and/or annotation information and wherein the representation information and/or annotation information is stored separately from at least part of the information to unrandomise said representation and/or annotation information, and wherein said method comprises or includes accessing said information to unrandomise said representation information and/or annotation information, unrandomising the representation information and/or the annotation information using said information to unrandomise said representation information and/or annotation information to yield a unrandomised representation of the nucleotide sequence of at least part of the genome of at least one individual and/or randomised annotation information relating to said genome(s).

Preferably, access to at least some of said information to unrandomise said representation information and/or annotation information may be authorised only by and/or is controlled by the one or more individuals whose genomic information may thereby be unrandomised and/or wherein at least some of said information to unrandomise said representation and/or annotation information is the property of the one or more individuals whose genomic information may thereby be unrandomised.

In yet a further aspect, the invention provides a method to increase the informativeness of stored genomic information wherein said method comprises or includes a method of processing genomic information as herein described with or without reference to the examples herein.

In still a further aspect, the present invention provides processed genomic information wherein said processed genomic information is provided in more than one dataset, and wherein at least part of at least one such dataset comprises a randomised representation of the nucleotide sequence of at least part of the genome of at least one individual and/or randomised annotation information relating to said genome, and wherein at least one other dataset comprises at least part of the information required to unrandomise the representation and/or annotation information.

Preferably, the dataset comprising at least part of the information required to unrandomise the representation is stored in a portable storage device. More preferably, said portable storage device is the property of the individual or individuals whose genomic information may thereby be unrandomised.

In a yet further aspect, the invention provides processed genomic information processed in accordance with methods or processes as herein described with or without reference to the examples herein.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

The invention consists in the foregoing and also envisages constructions of which the following gives examples only.

### DESCRIPTION OF THE FIGURES

Preferred embodiments of the invention will now be described with reference to the accompanying drawings in which:

FIG. 1 depicts a graphical representation of a process by which annotation information relating to genonaic information can be processed (FIG. 1A) and an example thereof (FIG. 1B).

FIG. 2 depicts a graphical representation of a process by which genomic information can be processed (FIG. 2A) and an example thereof (FIG. 2B).

FIG. 3 depicts a graphical representation of a process by which processed genomic information can be reconstructed (FIG. 3A), and an example thereof (FIG. 3B).

### DETAILED DESCRIPTION OF THE INVENTION

As broadly outlined above, the invention provides methods and process that are directed to techniques and processes for encrypting, storing and managing genomic information.

As used herein, genomic information includes a representation of a sequence of nucleotide bases for at least a portion of the genome of an individual and/or the genomes of individuals comprising a population, such as for example, a family. The sequence of nucleotide bases can be determined from either a DNA sample or an RNA sample of the individual or the individuals comprising a population. The DNA or RNA sample(s) can be sequenced by methods well known in the art to determine either a partial nucleotide sequence or an entire nucleotide sequence of the genome of an individual or the individuals comprising a population. Rapid sequencing methods, such as for example those described in WO 02088382 to Genovoxx GmbH, are particularly amendable to use in the methods and processes of the invention.

Further, a sequence of nucleotide bases can be determined from a messenger RNA (mRNA) sample from an individual or the individuals comprising a population, or equivalently from copy DNA (cDNA) synthesized from the mRNA sample(s).

As the genomic information of an individual or individuals comprising a population to which the present invention is directed represents a genome that comprises deoxyribonucleic acid (DNA) nucleotides, genomic information will generally comprise a representation of DNA nucleotide sequence. For DNA, the common nucleotide bases comprising the sequence are selected from adenine (A), cytosine (C), guanine (G), and thymine (T). DNA nucleotide sequence can be represented by a string comprising the characters “A”, “C”, “T” and “G”.

Notwithstanding this, genomic information can also comprise a representation of ribonucleic acid (RNA) nucleotide sequences. For RNA, the common nucleotide bases comprising the sequence are selected from adenine (A), cytosine (C), guanine (G), and uracil (U). RNA nucleotide sequence can be represented by a string comprising the characters “A”, “C”, “G” and “U”. A representation of nucleotide sequence as an RNA nucleotide sequence may be used, for example, where the nucleotide sequence comprises a nucleotide sequence that can be transcribed into RNA, such as for example, a protein-encoding gene or a ribosomal RNA gene. As those skilled in the art should know, a representation of an RNA sequence can be readily converted into a representation of a DNA sequence, and vice versa.

Regardless of whether a DNA or an RNA sample is sequenced, the representation can include an uncompressed sequence of codes, such as for example, two-bit codes, wherein each code indicates one of four different nucleotide bases which comprise the sequence. Alternatively, the representation can include a lossless, compressed representation of the sequence. Various lossless data compression techniques known in the art can be utilized for this purpose. The genomic information comprising the representation of the nucleotide sequence may then be processed by the methods and processes of the invention as described herein.

As used herein, genomic information further includes annotation information for nucleotide sequence. Annotation information comprises information about a nucleotide sequence, and may include any information relating to the physical and biological context of a nucleotide sequence. Annotation information includes name information, such as for example, the name or names of a gene or genes associated with a nucleotide sequence, source information, such the source from as which the nucleotide sequence originated, location information, such as the location of the nucleotide sequence within the genome, such as for example, the chromosomal and/or subchromosomal location, and the position within the nucleotide sequence of nucleotide sequences of interest, such as for example, expressed sequence tags (EST), genetic markers, single nucleotide polymorphisms (SNPs), microsatellites, the beginning and end of genes, transcriptional and translational regulatory regions such as, for example insulators, distal enhancers, upstream enhancers, silencers, proximal promoters, core promoters, transcription factor binding sites, ribosomal binding sites, internal ribosome entry sites, upstream open reading frames, polyA-binding protein binding sites, and the like.

Annotation information for a nucleotide sequence also comprises information about its biological context. For example, for a nucleotide sequence comprising a gene or gene fragment, this may include its associated primary sequence entry in public sequence databases such as Genbank, its membership in a Unigene sequence cluster, its association with a known gene in LocusLink, and a characterization of the function of the gene and its involvement in, for example, a metabolic pathway.

As those skilled in the art should appreciate, GenBank is the National Institutes of Health (“NIH”) genetic sequence database, an annotated collection of all publicly available DNA sequences that is available on the Internet at www.ncbi.rilm.nih.gov/Genbank. In addition, UniGene is a system for automatically partitioning GenBank sequences into a non-redundant set of gene-oriented clusters and is available at www.ncbi.nlm.nih.govUniGene/. Finally, LocusLink provides a single query interface to curated sequence and descriptive information about genetic loci and. is available at www.ncbi.nlm.nih.gov/LocusLink/. LocusLink presents information on official nomenclature, aliases, sequence accessions, phenotypes, Enzyme Commission (EC) numbers, Mendelian Inheritance in Man (MIM) numbers, UniGene clusters, homology, map locations, and related web sites.

Genomic information annotation, including, for example, nucleotide sequence annotation or amino acid sequence annotation, generally involves integrating information from a variety of genomic data sources, such as, for example, GenBank or SwissProt.

An important aspect of annotation information is the evolution of the science underlying recorded nucleotide sequence and or amino acid sequence annotations, including gene annotations. For example, the associations of nucleotide sequence fragments with a known gene or genes may change because of the evolution of Unigene clusters or amendments to the known gene entries recorded in LocusLink. The evolution of nucleotide sequence annotation data, including gene annotation data, may affect the result of genomic information data analysis, such as for example, the association of a disease with a particular nucleotide sequence. Therefore, nucleotide sequence annotation data should advantageously be tracked. It should be appreciated that changes relating to nucleotide sequence information reflect changes in what is currently known about scientific facts. Accordingly, annotation information, including nucleotide sequence annotation information, and gene annotation data should not only be extracted, validated, and integrated into one or more annotation datasets, but also should advantageously be refreshed to reflect the evolution of science.

The genomic information may be stored in one or more datasets. Any such dataset may comprise a representation of part or all of the sequence of nucleotide bases comprising the genomic information. Any such dataset may additionally or alternatively comprise annotation information for nucleotide sequence.

The methods and processes described herein operate to increase the security of one or more datasets where such information is stored by at least in part reducing the informativeness of any one or more parts of the genomic information.

This can be achieved by, for example, a physical separation of datasets comprising parts of the genomic information, and/or by processing and/or encrypting part or all of one or more datasets that comprise part or all of the genomic information.

The present invention recognizes that in order to be informative, a nucleotide sequence, such as, for example, part or all of a gene or part or all of an individual or population's genome, must be substantially in the correct order.

The present invention further recognizes that in order to be informative, a nucleotide sequence, such as, for example, part or all of a gene or part or all of an individual or population's genome, must be substantially present. The informativness of a nucleotide sequence of any length will be reduced if it is neither substantially present nor substantially in the correct order. This can be illustrated with the simple example of the trinucleotide sequence TGA. In the correct order, TGA may if present in-frame in the coding sequence of a protein-encoding gene, represent the termination codon of said gene, or in certain examples may represent a selenocysteine codon. If the order of the nucleotides comprising the trinucleotide within the sequence is incorrect, such as for example, ATG, this trinucleotide may instead represent a Methionine codon and/or a start codon, thereby reducing the informativeness of the sequence comprising the misordered trinucleotide sequence with respect to the correct sequence. Alternatively, if the sequence is not substantially present, for example, it lacks the third nucleotide being present only as TG, it is impossible to determine solely from this information which of the four possible common deoxyribonucleotides A, C, G or T, are present at the third position. It is therefore impossible to determine whether the complete trinucleotide represents a Cysteine codon, a Tryptophan codon, or a termination codon or in certain examples a selenocysteine codon, and again the informativeness of the nucleotide sequence is reduced.

Alignment of one ‘query’ nucleotide sequence with a reference nucleotide sequence may allow the identification of the ‘query’ sequence. Various methods for the alignment of nucleotide sequences are well known in the art. However, if the entire sequence of the ‘query’ sequence is not present, an accurate determination of that ‘query’ sequence may not be possible and the informativeness of the query sequence may be reduced. For example, if the incomplete ‘query’ sequence comprises or spans part or all of a gene which is part of a family of closely related and/or homologous and/or similar genes, or if the incomplete ‘query’ sequence comprises or spans part or all of a conserved sequence motif and/or a consensus sequence, then a determination of to which gene within said family or to which gene comprising said conserved sequence motif or consensus sequence the incomplete ‘query’ sequence belongs may be impossible.

In another example, the informativeness of a nucleotide sequence can be reduced even when the identity of the incomplete ‘query’ sequence is known, such as, for example, when the identity of the gene comprising the incomplete ‘query’ sequence has been determined. This is particularly the case when a nucleotide sequence may contain single nucleotide polymorphisms. For example, if it is determined that an incomplete ‘query’ nucleotide sequence spans a genomic region that contains a common single nucleotide polymorphism, by, for example, alignment with known sequence, there exists the possibility that the nucleotide in the position of the single nucleotide polymorphism is not present in the incomplete ‘query’ nucleotide sequence. Here, the informativeness of the incomplete ‘query’ sequence is reduced. This is of particular importance in situations where a single nucleotide polymorphism is associated with a disease.

The informativeness of genomic information, such as a nucleotide sequence, such as, for example, part or all of a gene or part or all of an individual's or population's genome, and/or annotation information can be reduced by the separation of the genomic information into more than one dataset.

The separation of the genomic information into more than one dataset may be performed by, for example, a splitting algorithm. The function of a splitting algorithm is to randomise a sequence and generate information that can later be used to unrandomise the sequence. Randomisation is done in such a way that the product of the randomisation has reduced informativeness. In one embodiment, one or more datasets comprise at least part of the randomised nucleotide sequence or sequences, and one or more datasets comprise part or all of the information required to unrandomise the nucleotide sequence(s).

In another embodiment, one or more datasets comprise at least part of the randomised annotation information, and one or more datasets comprise part or all of the information required to unrandomise the annotation information.

Any process capable of dividing a nucleotide sequence into more than one components, randomising said components in order to reduce the informativeness of the nucleotide sequence, and generating information which can be used to unrandomise said components thereby to restore the informativeness of the nucleotide sequence, can be used. Any such method or process may be used in combination and/or in an iterative or recursive manner, wherein anyone or more outputs of a division and randomisation process is the input for a subsequent division and randomisation process.

The separation of the genomic information into more than one dataset may comprise the separation of nucleotide sequence information and annotation information. Importantly, it should be recognized the annotation information may be divided and randomised by the methods and processes of the present invention described herein with reference to nucleotide sequence information.

Datasets may conveniently be stored in a machine-readable storage medium.

One or more such datasets may be stored in a central database. Conveniently the central database is remotely accessible, for example as part of a local area network, a wide area network or by way of connection to the Internet. Access to the database and/or the datasets stored therein can be controlled by authentication procedures and processes well known in the art. However the security of the genomic information stored in a central database is not solely reliant upon authentication procedures and/or encryption methods as at least one dataset required to render the genomic information informative is stored separately from any such central database or databases. In a preferred embodiment, one or more such datasets are stored in a portable electronic storage device (whether an optical storage device, such as, for example, a CD-ROM, or a solid state device, such as, for example, a ROM memory chip or the like). In another preferred embodiment, at least one dataset is stored in a central database and at least one dataset is stored in a portable electronic storage device, wherein only the combination of the datasets stored on the database and the portable electronic storage device render-the genomic information stored therein informative.

One or more of said datasets may be encrypted. Methods for encrypting data are well known in the art and described in the literature, for example, in Bruce Schneier, Applied Cryptography (Addison-Wesley 1996). Any part of the information in any one or more datasets may be encrypted. Indeed any parts of the information of any one or more datasets may be encrypted by different encryption methods.

Aspects of the invention will now be described with reference to the following non-limiting examples.

### Example One

The following example illustrates a process by which the genomic information of an individual or population can be prepared for secure storage. Genomic information comprising nucleotide sequence information and annotation information is processed as follows.

Genomic information may initially be processed so as to divide the information into smaller parts to make it easier to work with the data.

The nucleotide sequence information to be split is divided into parts that represent a continuous sequence. A sequenced mammalian genome contains one continuous sequence for each chromosome. In the case of the whole genome, the nucleotide sequence information is divided into a set of sequences where each sequence represents one chromosome.

The nucleotide sequence is annotated to yield annotation information. Annotation information comprises the following entries for each gene in the human genome:

Gene name;

Chromosomal location(s) of the gene and/or copies of the gene;

The number of copies of the gene;

For each copy of the gene:
Index of the start nucleic acid;
Index of the end nucleic acid;
The identity of the nucleotide sequence fragment or fragments in which the copy or copies of the gene can be found.

Optionally, annotation information for genes that do not exist in the particular genome to which the annotation information relates may be included within the annotation information, to yet further reduce the informativeness of the processed genomic information.

The nucleotide sequence of each chromosome is divided into equal length fragments. As the division is performed the annotation information is updated so that the start and end indices for each gene copy are relative to the start of the fragment, and the identity of the fragment is added to the annotation information.

This processing yields one annotation and many sequence fragments for each chromosomal nucleotide sequence.

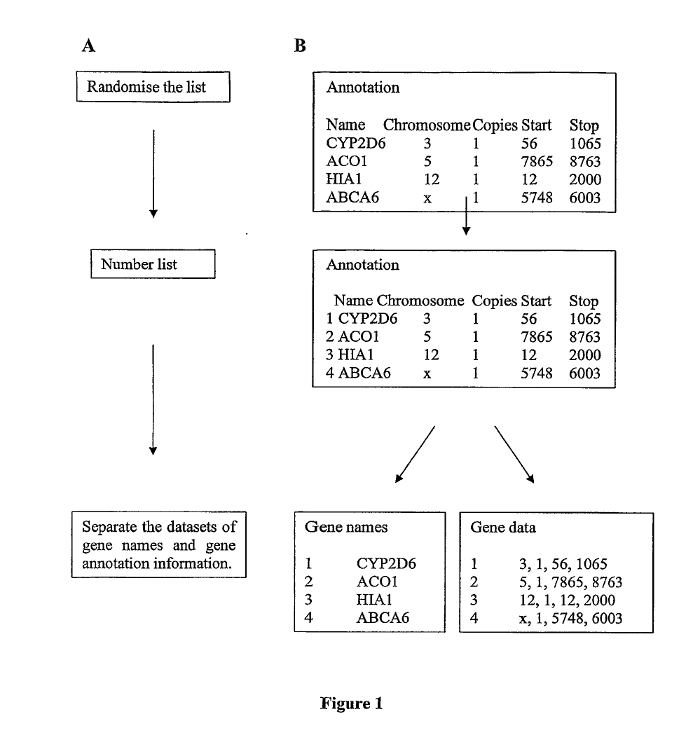

In order to further enhance security, reduce the informativeness of the genomic information, and avoid unauthorised third parties obtaining any annotation information, such as for example, the number of genes comprising the genomic information, the annotation information is processed as shown in FIG. 1.

The list of annotation entries is randomised, and then numbered. Two datasets are created by splitting the randomised annotation list. The gene names are then separated from the rest of the data to create the two datasets, wherein one dataset comprises a list of gene names, and the second comprising a corresponding list of gene data.

The nucleotide sequence information is processed by the following algorithm which further splits the sequence fragments. This splitting algorithm can be applied to any length sequence fragment.

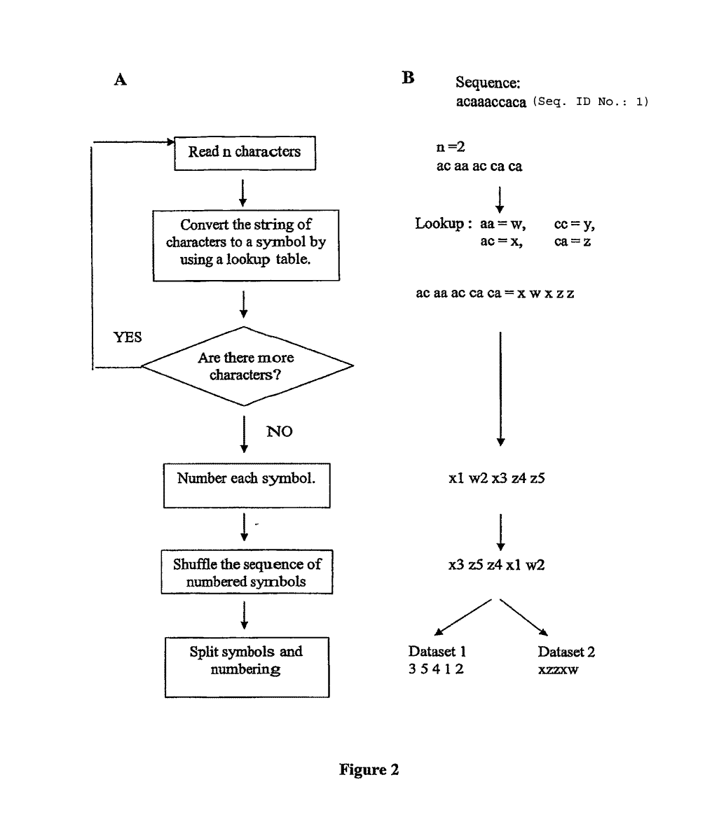

The function of the splitting algorithm is to randomise a sequence and generate information that can later be used to unrandomise the sequence. The randomisation is to be done in such a way that the resulting nucleotide sequence information becomes uninformative. The following sections describe one of the many algorithms that could be employed to perform the splitting, and are graphically represented in FIG. 2.

The size of the file comprising the nucleotide sequence information is reduced by reading n characters of the sequence and converting the string of characters to a symbol that uniquely identifies that string. The next n characters are then read and converted. This process is continued until no unconverted sequence is left. The choice of string length influences the resulting data compression and the size of the lookup tables required.

The conversion is preformed by, for example, using a lookup table. A possible lookup table for n=2 is the following:

| | | | |
|---|---|---|---|
| aa = a | ga = e | ca = i | ta = m |
| ag = b | gg = f | cg = j | tg = n |
| ac = c | gc = g | cc = k | tc = o |
| at = d | gt = h | ct = l | tt = p |

The symbols (unique identifiers) are then numbered wherein the number corresponds to a positional identifier.
The list of symbols and positional identifiers is then randomised.

The sequence information is split by separating the symbol (unique identifier) and the positional identifier of each pair, whilst maintaining the association between the unique identifier and the positioned identifier by way of an association identifier so that unrandomisation can be implemented. The two resulting datasets are the randomised nucleotide sequence information and a key comprising positional identifiers and association identifiers. Here, the association identifier is the relative position of the symbol and positional identifier within each dataset.

The key dataset is stored on a portable storage device and the nucleotide sequence information dataset is stored on a central database. As described herein, in other examples, part or all of any dataset may be stored either in a portable storage device or a central database or multiple databases. Dataset storage decisions are typically dependant on storage and convenience costs.

When authorised, use of the genomic information is implemented by use of reconstruction algorithm.

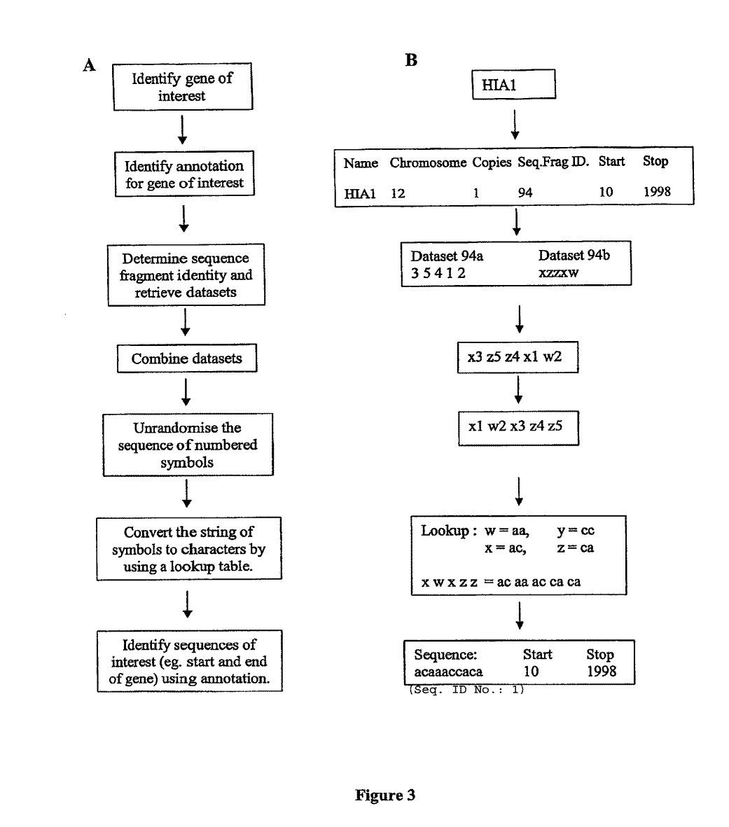

The function of the reconstruction algorithm is to use the key generated in the splitting algorithm to unrandomise the sequence (FIG. 3A). The following algorithm is one example of how a reconstruction algorithm is implemented. The nucleotide sequence of a gene is reconstructed as follows with reference to FIG. 3B.

The position of the gene in the gene name dataset is determined.

The annotation information relating to the gene is determined by way of the relative position of the annotation information within the annotation information dataset.

The identity of the randomised nucleotide sequence fragment within which the gene is located is determined from the annotation information. The annotation information also provides the related key information to unrandomise the nucleotide sequence.

The dataset comprising the positional identifiers and the dataset comprising the sequence symbols are combined.

The sequence symbols are unrandomised utilizing the positional identifiers as shown in FIG. 3B by sorting in ascending order.

The nucleotide sequence of the fragment is reconstructed by expansion of the unrandomised symbols using the lookup table.

The sequence of the gene is then determined with reference to the index of the beginning and end of the gene present in the annotation information.

In examples where the nucleotide sequence of a gene is present in more than one sequence fragment, each sequence fragment is reconstructed to yield the nucleotide sequence of the gene.

It will be appreciated that the above description is provided by way of example only and it is not the intention to limit the scope of the invention to the abovementioned examples only. As would be appreciated by a skilled person in the art, many variations are possible, for example variations in both the materials and the techniques used which are known to those persons skilled in the art, and such variations are contemplated without departing from the scope of the invention (as set out in the accompanying claims).

1. A method for securely storing genomic information, said method comprising obtaining genomic information of one or more individuals, separating the genomic information into more than one dataset, storing at least one such dataset in a portable storage device, and storing the remainder of the datasets in at least one central database, wherein the portable storage device is the property of the one or more individuals whose genomic information is partly contained therein, and wherein the genomic information is rendered informative only when the dataset or datasets stored in the portable storage device is combined with the dataset or datasets stored in the central database or databases.

2. The method according to claim 1 wherein the information of one dataset may at least in part overlap with that of another dataset.

3. The method according to claim 1 wherein the information in at least one dataset may be encrypted.

4. The method according to claim 1 wherein the information present in one dataset that is also present in one or more other datasets is encrypted.

5. The method according to claim 1 wherein the information of at least one dataset is encrypted and one or more other datasets provides one or more keys for decryption.

6. The method according to claim 1 wherein the information of at least one dataset is encrypted and more than one encryption method is used to encrypt different parts of the information comprising the dataset(s).

7. The method according to claim 1 wherein said genomic information comprises nucleotide sequence information and/or annotation information.

8. A method for processing genomic information for secure storage wherein said genomic information comprises a representation of the nucleotide sequence of at least part of the genome of at least one individual, said method comprising converting a nucleotide sequence into one or more fragments, representing the nucleotide sequence of one or more of said fragments by means of a unique identifier, denoting the unique identifier representing a fragment by means of a positional notation according to the position of the represented fragment in the nucleotide sequence, separating at least some of the positional notation(s) and at least some of the unique identifier(s) into at least two data sets, storing at least some of at least one dataset in a portable electronic storage device, and storing at least the remainder of the dataset(s) on at least one central database, wherein the portable storage device is the property of the one or more individuals whose genomic information is partly contained therein, and wherein the genomic information is rendered informative only when the dataset or datasets stored in the portable storage device is combined with the dataset or datasets stored in the central database or databases.

9. A method for processing genomic information for secure storage wherein said genomic information comprises a representation of the nucleotide sequence of at least part of the genome of at least one individual, said method comprising converting a nucleotide sequence into one or more fragments, representing the nucleotide sequence of one or more of said fragments by means of a unique identifier, denoting the unique identifier representing a fragment by means of a positional notation according to the position of the represented fragment in the nucleotide sequence, separating at least some of the positional notation(s) and at least some of the unique identifier(s) into at least two data sets, storing at least some of at least one dataset separately from the remainder of the dataset(s), wherein access to at least some of at least one dataset may be authorised only by and/or is controlled by the one or more individuals whose genomic information is partly contained therein and/or wherein at least some of at least one dataset is the property of the one or more individuals whose genomic information is partly contained therein, and wherein the genomic information is rendered informative only when the datasets are combined.

10. The method according to claim 9 wherein the representation of the sequence of nucleotides of the one or more fragments by a unique identifier is facilitated by means of a method which correlates a string of n characters of a representation of a nucleotide sequence with a unique identifier which identifies that string.

11. The method according to claim 10 wherein said method utilises a lookup table.

12. The method according to claim 9 wherein the nucleotide sequence is converted into fragments of the same length.

13. The method according to claim 9 wherein the nucleotide sequence is converted into fragments of varying lengths.

14. The method according to claim 9 wherein the method comprises randomising the sequence of unique identifiers and their associated positional notations, and separating at least some of the positional notations from at least some of the unique identifiers whilst maintaining the association of each unique identifier with its associated positional notation.

15. The method according to claim 14 wherein the association of a given unique identifier with its positional notation is maintained by their relative position within each dataset.

16. The method according to claim 14 wherein the association of a given unique identifier with its positional notation is provided by a unique association identifier.

17. The method according to claim 9 wherein said unique identifier(s) and/or positional notation(s) and/or association identifier(s) is or are alphanumeric.

16. A method for reducing the informativeness of genomic information for the secure storage of said genomic information, wherein said genomic information comprises representation information comprising a representation of the nucleotide sequence of at least part of the genome of at least one individual and/or annotation information relating to said genome, and wherein said method comprises obtaining genomic information of one or more individuals, randomising the representation of the nucleotide sequence and/or the annotation information according to a process that generates information to unrandomise said representation information and/or annotation information, and separating said representation information and/or annotation information from the information to unrandomise said representation and/or annotation information, wherein access to at least some of said information to unrandomise said representation information and/or annotation information may be authorised only by and/or is controlled by the one or more individuals whose genomic information may thereby be unrandomised and/or wherein at least some of said information to unrandomise said representation and/or annotation information is the property of the one or more individuals whose genomic information may thereby be unrandomised, and wherein the genomic information is rendered informative only when the representation information and/or annotation information and the information to unrandomise said representation information and/or annotation information are combined.

19-20. (canceled)

21. A method for increasing the informativeness of stored genomic information, wherein said stored genomic information comprises or includes two or more separately stored datasets, at least one of which is stored in a portable storage device and the remainder of which are stored in at least one central database, and wherein the genomic information of any dataset(s) is uninformative in the absence of the remainder of datasets, said method comprising or including accessing said datasets, and combining the information of said datasets thereby to yield informative genomic information.

22. A method for increasing the informativeness of processed genomic information wherein said processed genomic information is provided in more than one dataset, and wherein at least part of at least one such dataset comprises a randomised representation of the nucleotide sequence of at least part of the genome of at least one individual and/or randomised annotation information relating to said genome, and wherein at least one other dataset comprises at least part of the information required to unrandomise at least part of said representation and/or annotation information, said method comprising or including accessing said dataset(s) comprising at least part of the information required to unrandomise at least part of said representation and/or annotation information, and unrandomising said representation and/or annotation information to yield informative genomic information.

23. A method for increasing the informativeness of stored genomic information, wherein said stored genomic information comprises randomised representation information comprising a randomised representation of the nucleotide sequence of at least part of the genome of at least one individual and/or randomised annotation information relating to said genome(s) and information to unrandomise said representation information and/or annotation information and wherein the representation information and/or annotation information is stored separately from at least part of the information to unrandomise said representation and/or annotation information, and wherein said method comprises accessing said information to unrandomise said representation information and/or annotation information, unrandomising the representation information and/or the annotation information using said information to unrandomise said representation information and/or annotation information to yield a unrandomised representation of the nucleotide sequence of at least part of the genome of at least one individual and/or randomised annotation information relating to said genome(s).

24. The method according to claim 22 wherein access to at least some of said information to unrandomise said representation information and/or annotation information may be authorised only by and/or is controlled by the one or more individuals whose genomic information may thereby be unrandomised and/or wherein at least some of said information to unrandomise said representation and/or annotation information is the property of the one or more individuals whose genomic information may thereby be unrandomised.

25. (canceled)

26. Processed genomic information wherein said processed genomic information is provided in more than one dataset, and wherein at least part of at least one such dataset comprises a randomised representation of the nucleotide sequence of at least part of the genome of at least one individual and/or randomised annotation information relating to said genome, and wherein at least one other dataset comprises at least part of the information required to unrandomise the representation and/or annotation information.

27. The genomic information according to claim 26 wherein the dataset comprising at least part of the information required to unrandomise the representation is stored in a portable storage device.

28. The genomic information according to claim 27 wherein said portable storage device is the property of the individual or individuals whose genomic information may thereby be unrandomised.

29. (canceled)

30. The method according to claim 23 wherein access to at least some of said information to unrandomise said representation information and/or annotation information may be authorised only by and/or is controlled by the one or more individuals whose genomic information may thereby be unrandomised and/or wherein at least some of said information to unrandomise said representation and/or annotation information is the property of the one or more individuals whose genomic information may thereby be unrandomised.


SEQUENCE LISTING (1 sequence)

SEQ ID NO: 1 - DNA, 10 bp, Artificial Sequence
  Made in a lab
acaaaccaca